(19) United States
(12) Patent Application Publication
(10) Pub. No.: US 2026/0201580 A1
(43) Pub. Date: Jul. 16, 2026

(54) CATALYST AND METHOD OF PREPARING THE CATALYST

(71) Applicant: NANYANG TECHNOLOGICAL UNIVERSITY, Singapore (SG)

(72) Inventors: Zheng LIU, Singapore (SG); Shasha GUO, Singapore (SG)

(73) Assignee: NANYANG TECHNOLOGICAL UNIVERSITY, Singapore (SG)

(21) Appl. No.: 19/131,296

(22) PCT Filed: Nov. 24, 2023
(86) PCT No.: PCT/SG2023/050785

§ 371 Date: May 20, 2025

(30) Foreign Application Priority Data
Nov. 25, 2022 (SG) 10202260211T

(51) Int. Cl. C25B 11/093; C25B 11/031; C25B 11/053; C25B 11/065; H01M 4/86; H01M 4/90; H01M 4/92

(52) U.S. Cl. CPC C25B 11/093; C25B 11/031; C25B 11/053; C25B 11/065; H01M 4/8605; H01M 4/9016; H01M 4/9083; H01M 4/926

(57) ABSTRACT

A catalyst comprising metal nanoparticles as active phase disposed on a solid support, and a porous layer comprising amorphous hafnium oxide disposed on the metal nanoparticles is provided A method of preparing the catalyst, and use of the catalyst in electrode, proton exchange membrane water electrolyzer, or fuel cell are also provided.

### CROSS-REFERENCE TO RELATED APPLICATION

This application claims the benefit of priority of Singapore patent application Ser. No. 10202260211T, filed 25 Nov. 2022, the contents of which being hereby incorporated by reference in its entirety for all purposes.

### TECHNICAL FIELD

Various embodiments relate to a catalyst and method of preparing the catalyst.

### BACKGROUND

Industrially relevant uphill reactions driven by electrocatalysis, which can produce renewable and clean feedstocks, can potentially be game-changers and transform the current global energy market dominated by fossil fuels.

In particular, hydrogen (H₂) is touted by many as the future sustainable fuel as it generates only water at the exhaust, and does not generate greenhouse gases. Due to increasing energy shortage and extreme climate, many ambitious plans are afoot to dramatically accelerate development of global hydrogen fueling economy, including constructing hydrogen refueling infrastructure, developing hydrogen-powered domestic applications, advancing fuel cell technologies, and powering transportation facilities.

Possibility of a hydrogen-based economy, however, may depend significantly on the technological readiness to produce large-scale, price-appealing hydrogen. At present, about 95% of this clean-burning gas is grey or blue hydrogen, produced by steam methane reforming, which requires massive energy generated by fossil fuel. Only the remaining 5% of hydrogen, so-called green hydrogen, is generated in a true emission-free fashion by technology involving water electrolyzer. Unfortunately, current cost of green hydrogen is more than twice that of the grey or blue version ($5/kg vs. $1 to $2/kg) and certainly higher than that of fossil fuels (diesel, $0.82/kg).

Costs of technology involving water electrolyzer is dominated by the catalyst coated membrane (40 to 50%), with platinum as the capital cost. Urgent demand for terawatt (TW)-scale clean energy necessitates rational design of noble metal catalysts with minimal noble metal loading while maintaining high catalytic activity. However, durability of low-loading catalysts is a critical concern for their successful industrial implementation.

To realize commercial low-cost renewable hydrogen, intense academic efforts have been devoted to developing hydrogen evolution electrocatalysts with high efficiency, low costs, and high durability. So far, platinum (Pt)-based catalyst is regarded as the champion catalyst for hydrogen evolution reaction (HER) due to optimized hydrogen adsorption energy. Unfortunately, the practical price barrier needs to be surmounted because Pt is in high demand but in low abundance.

To meet the global energy demand (total energy supply in 2018 reached 18.83 terawatts), scaling up of the energy stored in H₂ on the terawatt scale is needed. Even with Pt loading of 0.25 mg cm⁻², about 100 tonnes of Pt (60% of annual production) are required for generating hydrogen at the terawatt level. Thus, there is a need to reduce the Pt catalyst tonnage requirement and increase the intrinsic activities of Pt-based catalysts, that is, mass activities, not geometric activities.

Extensive research on this aspect has delivered various advanced Pt-based catalysts with high Pt utilization, ranging from needle-like nanostructures, rods, cages, frames, cavities, supported monolayer (ML) films, binary (ternary) alloys, core-shell nanoparticles, and even supported single Pt atoms/nanoparticle/(sub) monolayer catalysts. For example, Pt skin surfaces of alloy can demonstrate 10-fold enhanced specific activity than that of single metal Pt electrode. However, large-scale production of green hydrogen requires further downsizing the current Pt loading per cm⁻² from 0.5 to 1.0 mg to several ug, even tens of ng scale, under the premise of comparable geometric activities.

Driven by nontrivially lowering costs while maintaining performance, extensive efforts have been spurred in constructing low metal loading catalysts, including nanoalloys, shape-controlled nanostructures, supported metal skins, and supported single atoms. However, nanocatalysts developed thus far are not optimal in that they tend to suffer from fast degradation—including Ostwald ripping, leaching, relocation, poisoning, etc.—which pose serious impediments to the massive deployment of clean energy technologies but receive much less research attention. Particularly, instability issues are exacerbated when size of nanomaterials is further reduced due to the significantly higher specific surface energy and decreased cohesive energy. As such, such catalysts are far from meeting practical lifetime targets (e.g., 5000-8000 h for light-duty automotive vehicles). As a typical example, the performance fading rate of 3 nm-Pt particles is 30-fold and 500-fold higher than that of 5 nm-particles and well-defined single-crystalline materials, respectively.

Accordingly, longevity issues of Pt-based catalysts remain a concern. Even if significant reduction of Pt-based electrocatalyst tonnage requirement can be realized, time between replacement of the catalysts, whereby they stably operate, have to be managed. The acidic electrolysis works in harsh conditions, specifically, corrosive solution and elevated temperature (80° C.). Besides, catalyst atoms constantly rearrange at the electrolyte-catalyst interface under operation, triggering inevitable migration, aggregation (Ostwald ripping), and dissolution. This structural transformation is particularly true for supported low dimensional Pt-based catalyst systems due to much higher specific surface energy, as related to Gibbs-Thompson theory. Moreover, migration of Pt nanoparticles can be facilitated by the mechanic stress due to the generated H₂ bubbles, following by coalescence, agglomeration, leading to the loss of available electrochemical active surface area (ECSA).

To tackle instability challenges, support engineering approaches, such as doping (for example, S-doped carbon supported metal nanoparticles), chemical modification (such as aniline stacked graphene), and crystal edge stabilization (for example, Pt nanoparticles on MgO crystal edge), have been developed to enhance the metal-support interaction, showing elongated electrochemical or thermal durability.

Enormous interface engineering strategies have also emerged to solve stability challenges of the low dimensional Pt-based catalyst system, targeting to increase physical/chemical barriers to deactivation. Interface engineering enables effectively tailoring of Pt-support binding strength, further alleviating the Pt species migration/coalescence. Besides, the proton-conducting ionomer confined approach is consciously or unconsciously applied during the electrochemical measurement. While the ionomers as binding agents can protect the Pt species, they tend to also block active sites, influence the local electronic conductivity, and impede H₂-related mass transport.

Unfortunately, the afore-mentioned strategies are insufficient to prevent the loss of ECSA driven by metal electromigration and electrochemically induced atomic migration during long-time stability test. Materials with large loading are tested to evaluate electrochemical stability, however, stability of such catalysts cannot be determined, as the thicker film could exhibit activity, even it degrades seriously as long as not all the material has corroded away.

In light of the above, there exists a need for an improved catalyst and method of preparing the catalyst that address or at least alleviate one or more of the above-mentioned problems.

### SUMMARY

Various embodiments refer in a first aspect to a catalyst comprising metal nanoparticles as active phase disposed on a solid support, and a porous layer comprising amorphous hafnium oxide disposed on the metal nanoparticles.

Various embodiments refer in a second aspect to a method of preparing a catalyst, the method comprising forming metal nanoparticles as active phase on a solid support, and disposing a porous layer comprising amorphous hafnium oxide on the metal nanoparticles.

Various embodiments refer in a third aspect to use of the catalyst according to the first aspect or prepared by a method according to the second aspect in electrode, proton exchange membrane water electrolyzer, or fuel cell.

### BRIEF DESCRIPTION OF THE DRAWINGS

In the drawings, like reference characters generally refer to the same parts throughout the different views. The drawings are not necessarily drawn to scale, emphasis instead generally being placed upon illustrating the principles of various embodiments. In the following description, various embodiments of the invention are described with reference to the following drawings.

FIG. 1 is a schematic diagram depicting a process 100 for preparing a catalyst as disclosed herein. E-beam deposition 150 may be used to deposit single atoms or nanoclusters on a solid support 101. The single atoms or nanoclusters may coalesce to form metal nanoparticles 103, and be present as active phase on the solid support 101. While the metal nanoparticles 103 are being formed, and/or after the metal nanoparticles 103 are formed, the metal nanoparticles 103 may be subjected to atomic layer deposition 152. An oxygen precursor 105, such as H₂O, may be introduced with a hafnium precursor 107, such as [(CH₃)₂N]₄Hf, in alternating sequence, for a number of cycles. The oxygen precursor and the hafnium precursor may react or be converted in a next step 154, to form a porous layer 109 comprising amorphous hafnium oxide on the metal nanoparticles 103.

FIG. 2 is a representative atomic-resolution high-angle annular dark-field scanning transmission electron microscopy (HAADF-STEM) image of the as-deposited Pt single atom/nanoclusters with an evaporation time of 10 s, denoted as Pt_{0.1nm}.

FIG. 3A depicts monodispersed Pt single atom/nanoclusters on graphene, whereby an atomically resolved STEM image of the distribution of Pt species just evaporated onto graphene substrate as increasing the deposition time at a rate of 0.1 Å/s for forming 0.005 nm Pt thickness is shown.

FIG. 3B depicts monodispersed Pt single atom/nanoclusters on graphene, whereby an atomically resolved STEM image of the distribution of Pt species just evaporated onto graphene substrate as increasing the deposition time at a rate of 0.1 Å/s for forming 0.01 nm Pt thickness is shown.

FIG. 3C depicts monodispersed Pt single atom/nanoclusters on graphene, whereby an atomically resolved STEM image of the distribution of Pt species just evaporated onto graphene substrate as increasing the deposition time at a rate of 0.1 Å/s for forming 0.02 nm Pt thickness is shown.

FIG. 3D depicts monodispersed Pt single atom/nanoclusters on graphene, whereby an atomically resolved STEM image of the distribution of Pt species just evaporated onto graphene substrate as increasing the deposition time at a rate of 0.1 Å/s for forming 0.1 nm Pt thickness is shown.

FIG. 3E depicts plot of Pt mass loading versus deposited thickness for monodispersed Pt single atom/nanoclusters on graphene.

FIG. 4A is an atomic-resolution HAADF-STEM image of m-HfO₂@Pt_{0.1nm} on graphene with m-HfO₂ in thickness of 3 nm.

FIG. 4B is an atomic-resolution HAADF-STEM image of m-HfO₂@Pt_{0.1nm} on graphene with m-HfO₂ in thickness of 10 nm.

FIG. 5 is energy dispersive X-ray (EDX) element mapping of 3 nm m-HfO₂@Pt_{0.1nm} on graphene, for Pt, O, Hf and C.

FIG. 6A depicts typical Raman spectra of 10 nm m-HfO₂@Pt_{0.1nm} on graphene, with Raman spectra of just evaporated Pt_{0.1nm} on graphene (620), and 10 nm m-HfO₂@Pt_{0.1nm} on graphene (610).

FIG. 6B is a table showing extracted ratio of I_{D}/I_{G} and I_{2D}/I_{G} from FIG. 6A, for just evaporated Pt_{0.1nm} on graphene (G-Pt) and 10 nm m-HfO₂@Pt_{0.1nm} on graphene (G-Pt-HfO₂).

FIG. 7 is Pt 4f X-ray photoelectron spectroscopy (XPS) spectra characterizing graphene supported 10 nm m-HfO₂@Pt_{0.1nm}.

FIG. 8 is a cross-section STEM image of 10 nm m-HfO₂@Pt_{0.1nm} on graphene, showing complete coverage of 2-3 nm Pt nanoparticles by a 10 nm thick m-HfO₂ layer. Scale bar denotes 5 nm.

FIG. 9A shows a typical O 1 s XPS spectra of 2 nm m-HfO₂@Pt_{0.1nm}.

FIG. 9B shows a typical Hf 4f XPS spectra of 2 nm m-HfO₂@Pt_{0.1nm}.

FIG. 10 is charge density distribution of m-HfO₂@Pt nanoparticle model. In embodiments, Pt (1003) are shown with O (1005) and Hf (1007), and charge accumulation and depletion regions are distinguished by (1010) and (1020), respectively (isovalue: 0.001).

FIG. 11 is a schematic diagram of hydrogen evolution process over graphene supported m-HfO₂@Pt_{0.1nm} according to embodiments. A porous layer of m-HfO₂ is disposed on Pt nanoparticles as a capping layer. In use, bubbles of hydrogen gas may evolve on the surface of m-HfO₂ instead of Pt nanoparticles.

FIG. 12A depicts typical polarisation curves of m-HfO₂@Pt_{0.1nm} with varied m-HfO₂ thickness of 5 nm (1210), 10 nm (1220), and 20 nm (1230).

FIG. 12B depicts typical Tafel plots of m-HfO₂@Pt_{0.1nm} with varied m-HfO₂ thickness of 5 nm (1210), and 10 nm (1220).

FIG. 13A is a photograph of the on-chip micro-flow device, or microelectrochemical setup for hydrogen evolution reaction (HER) measurement of 10 nm m-HfO₂@Pt_{0.1nm} on graphene as working electrode (WE). A carbon rod and leakless Ag/AgCl was used as counter electrode (CE) and reference electrode (RE), respectively. A syringe pump was used to continuously flow fresh electrolyte in the microcell.

FIG. 13B is a photograph of a conventional 3-electrode setup for hydrogen evolution reaction (HER) test of 10 nm m-HfO₂@Pt₁ₙₘ on carbon paper.

FIG. 14A is a graph showing 1st to 701th cycling LSV curves of 10 nm m-HfO₂@Pt_{0.1nm} on graphene in 0.5 M H₂SO₄, measured at the 1-cycle, 101-cycle, 201 cycle, 301-cycle, 401-cycle, 501-cycle, 601-cycle, and 701-cycle hydrogen evolution reaction (HER) test.

FIG. 14B is a graph showing derived overpotential at 10 mA cm⁻² versus Tafel slope.

FIG. 15A is a graph showing overpotential vs mass loading plot of materials disclosed herein along with that for various other Pt-based hydrogen evolution reaction (HER) catalysts.

FIG. 15B is a graph showing mass activities of materials disclosed herein along with mass activities for other Pt-based catalysts in 0.5 M H₂SO₄.

FIG. 16 is a schematic diagram of 4-electrode electrochemical impedance spectroscopy (EIS)-cell, where two platinum plates are working electrode and counter electrode, respectively, and two platinum wires are reference electrodes. L, W, and T denote distance between reference electrodes, and width and thickness of m-HfO₂@Pt deposited on graphene film, respectively.

FIG. 17 depicts a device fabrication process disclosed herein. A typical fabrication of an on-chip device may involve the following five major steps. Step 1) Conventional photolithography and e-beam evaporation were employed to pre-pattern 5 nm thick titanium (Ti)/50 nm thick gold (Au) contact pads on silicon dioxide/silicon (SiO₂/Si) substrates or transparent glass substrates. Step 2) chemical vapor deposition (CVD)-grown monolayer graphene film was transferred onto the on-chip devices by standard polymethyl methacrylate (PMMA)-assisted method (1701). Step 3) To disconnect adjacent electrodes, e-beam lithography (EBL) (1702) and O₂ plasma (20 W, 1 min) (1703) were employed to remove selected graphene channels. Step 4) Well-controlled m-HfO₂@Pt were synthesized on graphene via the aforementioned methods. Step 5) The reaction windows were exposed to the selected area by electron beam lithography (EBL) in 1-μm-thick PMMA protection film (1704), ensuring that the reaction only occurs in the region of interest.

FIG. 18A shows Nyquist plot of electrochemical impedance spectroscopy (EIS) for 10 nm m-HfO₂ membrane, for investigating HER activity and proton conductivity of graphene supported m-HfO₂@Pt_{0.1nm} by on-chip micro-cell systems.

FIG. 18B shows equivalent circuit model of FIG. 18A.

FIG. 19 depicts in-situ observation of electrochemically generated bubbles on 10 nm m-HfO₂@Pt_{0.5nm} surface. The scale bar is 1 μm.

FIG. 20 is a photograph of a typical H-cell setup for investigating scale up and generality, where anode (carbon rod) and cathode (catalyst) were separated by Nafion membrane.

FIG. 21A shows linear sweep voltammetry curve (LSV) curve of 10 nm m-HfO₂@Pt_{0.5nm} on carbon paper against Pt_{0.5nm} (2120).

FIG. 21B shows Tafel slope of 10 nm m-HfO₂@Pt_{0.5nm} on carbon paper for FIG. 21A.

FIG. 22A shows chronopotentiometry response of 10 nm m-HfO₂@Pt_{0.5nm} on carbon paper at a constant current density of 10 mA cm⁻², 20 mA cm⁻², and 40 mA cm⁻² in a H-cell, for Pt_{0.5nm} at 10 mA cm⁻² (2210), 10 nm HfO₂@Pt_{0.5nm} at 10 mA cm⁻² (2220), 10 nm HfO₂@Pt_{0.5nm} at 20 mA cm⁻² (2230), and 10 nm HfO₂@Pt_{0.5nm} at 40 mA cm⁻² (2240).

FIG. 22B shows chronopotentiometry curves of 10 nm m-HfO₂@Pt₁ₙₘ on carbon paper at a constant current density of 10 mA cm⁻², 20 mA cm⁻², and 40 mA cm⁻².

FIG. 23 depicts real time thermal stability study for graphene supported 3 nm m-HfO₂@Pt_{0.1nm}, for 0 minutes, 10 minutes, 20 minutes, 40 minutes, 50 minutes, and 60 minutes. Annular dark-field-scanning transmission electron microscope (ADF-STEM) in-situ imaging of the high temperature impact on the structure stability of m-HfO₂@Pt_{0.1nm}. The images were recorded at 500° C.

FIG. 24 shows real time thermal stability study for 3 nm m-HfO₂@Pt_{0.1nm} HAADF-STEM in-situ imaging of the high temperature impact on the structure stability of m-HfO₂@Pt_{0.1nm}, for initial, 10 minutes, 20 minutes, 30 minutes, 40 minutes and 50 minutes. The images were recorded at 700° C.

FIG. 25 is an exemplified atomic-resolution HAADF-STEM image of a 3 nm HfO₂@Pt_{0.1nm} on graphene, showing homogenous distribution of Pt nanoparticles. Scale bar denotes 50 nm.

FIG. 26A shows atomic-resolution HAADF-STEM image of 3 nm m-HfO₂@Co_{0.1nm} on graphene according to an embodiment. Scale bar denotes 100 nm.

FIG. 26B shows atomic-resolution HAADF-STEM image of 3 nm m-HfO₂@Co_{0.1nm} on graphene according to an embodiment. Scale bar denotes 100 nm.

FIG. 26C shows atomic-resolution HAADF-STEM image of 10 nm m-HfO₂@Co_{0.1nm} on graphene according to an embodiment. Scale bar denotes 10 nm.

FIG. 26D shows atomic-resolution HAADF-STEM image of 10 nm m-HfO₂@Co_{0.1nm} on graphene according to an embodiment. Scale bar denotes 10 nm.

FIG. 27A is a graph depicting typical polarization curves of m-HfO₂@Co_{0.2nm} with varied m-HfO₂ thickness for 5 nm HfO₂@Co_{0.2nm} (2710), 10 nm HfO₂@Co_{0.2nm} (2720), and 20 nm HfO₂@Co_{0.2nm} (2730), demonstrating OH ionic conductivity through m-HfO₂.

FIG. 27B is a graph depicting Tafel plots of m-HfO₂@Co_{0.2nm} with varied m-HfO₂ thickness, for 5 nm HfO₂@Co_{0.2nm} (2710), 10 nm HfO₂@Co_{0.2nm} (2720), and 20 nm HfO₂@Co_{0.2nm} (2730).

FIG. 28 is a graph depicting stability of Co_{0.5} nm (2810) and 10 nm HfO₂@Co_{0.5} nm (2820) on carbon paper at 10 mA cm⁻² during oxygen evolution in 1M KOH.

### DESCRIPTION

The following detailed description refers to the accompanying drawings that show, by way of illustration, specific details and embodiments in which the invention may be practised. These embodiments are described in sufficient detail to enable those skilled in the art to practise the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

Various embodiments disclosed herein relate to a scalable and precise method of synthesizing monodispersed Pt nanoparticles (NPs) on large-scale substrates with ultra-low loading, such as in the range of tens to hundreds nanogram per cm², for industrial-scale clean hydrogen production. Methods disclosed herein are able to eliminate structural transformation and extending the lifetime of supported Pt NPs.

A facile and universal protection design using rigid porous nonreducible oxide, amorphous HfO₂ (m-HfO₂), as a capping layer to enhance the lifetime of ultra-low loading electrocatalysts is disclosed herein. As a proof of concept, m-HfO₂ layer sheathed sub-monolayer Pt or Co nanoparticles (denoted as m-HfO₂@Pt or m-HfO₂@Co) on graphene were synthesized. By using amorphous HfO₂ (m-HfO₂) as a capping layer to provide spatial confinement to supported Pt NPs, and in so doing, prohibit electromigration and electrochemically migration of active Pt atoms, structural transformation of the Pt atoms may be prevented or even eliminated, and result in remarkably extended electrochemical durability.

In the experiments carried out, Pt/C catalysts with Pt loading as low as 81.39 ng cm⁻² have been obtained. It was demonstrated herein that the m-HfO₂ layer (which was at 10 nm) served as an efficient mass transport channel for underneath Pt active sites, and effectively mitigated bubble-induced blockage of active sites by separating bubble formation sites with Pt active sites. The resulting catalyst exhibited a remarkable mass activity of 122.87 A mg⁻¹ and an overpotential of 11 mV at 10 mA cm⁻². Furthermore, the m-HfO₂ played a crucial role in eliminating the structural transformation and extending the lifetime of Pt-based catalysts, as evidenced by no loss of specific activity after consecutively cycling the catalyst for over 100 hours. Such a capping strategy may potentially be applied to other types of reactions and catalyst systems.

Combining analytical tools such as atomic-resolution aberration-corrected high-angle annular dark-field (HAADF) scanning transmission electron microscopy (STEM), in-situ STEM, Raman spectroscopy, X-ray photoelectron spectroscopy (XPS) and on-chip microcells, it was demonstrated that in these configurations, holey or porous m-HfO₂ cover layers may play the following roles.

Firstly, the porous m-HfO₂ cover layer may firmly anchor highly dispersed metal nanoparticles (2-3 nm) onto the support. Further, the porous m-HfO₂ cover layer may provide abundant ion/gas-conducting channels to guarantee efficient mass transfer and efficiently separate bubble nucleate sites from Pt active sites. Next, the porous m-HfO₂ cover layer may have good thermal stability under 500° C. Last but not least, the porous m-HfO₂ cover layer may possess excellent anti-corrosion properties in acidic, neutral, and basic solutions.

As mentioned above, utility of the capping layer was demonstrated by preparing m-HfO₂@Pt on carbon paper and testing in a H cell configuration, showing world-record high mass activities (MAs) of 122.87 A mg⁻¹, and excellent durability under both 10 mA cm⁻² and 100 mA cm⁻².

With the above in mind, various embodiments refer in a first aspect to a catalyst comprising metal nanoparticles as active phase disposed on a solid support, and a porous layer comprising amorphous hafnium oxide disposed on the metal nanoparticles.

As used herein, the term “catalyst” refers to a substance that causes a change in the rate of a reaction, but is not consumed in the reaction. The catalyst may, for example, be a catalyst for hydrogen generation.

The catalyst comprises metal nanoparticles as active phase disposed on a solid support. Choice of metal nanoparticles may depend on the type of reaction. In various embodiments, the metal nanoparticles comprise a metal selected from the group consisting of platinum, palladium, cobalt, nickel, iron, iridium, aluminium, and alloys thereof. In some embodiments, the metal nanoparticles comprise or consist of platinum.

The metal nanoparticles may be of any shape. For example, each of the metal nanoparticles may be a sphere or irregularly shaped. In various embodiments, each of the metal nanoparticle is a sphere. As the shape of a metal nanoparticle may not always be regular, e.g. perfectly spherical, size of the metal nanoparticle may be characterized by a maximal dimension which refers to the maximum dimension of the metal nanoparticle in any direction. In embodiments where the metal nanoparticles are spherical, size of the metal nanoparticles may be defined by their average diameter.

The metal nanoparticles may have a size in the range from 0.1 nm to 5 nm, such as 1 nm to 5 nm, 2 nm to 5 nm, 3 nm to 5 nm, 0.1 nm to 4 nm, 0.1 nm to 3 nm, 0.1 nm to 2 nm, 1 nm to 4 nm, 1 nm to 3 nm, 2 nm to 4 nm, or 2 nm to 3 nm. In specific embodiments, the metal nanoparticles have a size in the range from 2 nm to 3 nm.

The metal nanoparticles may be homogeneously distributed on a surface of the solid support. In other words, the metal nanoparticles may be at least substantially well spread-out across a surface of the solid support.

In various embodiments, the metal nanoparticles are monodispersed in terms of size of the metal nanoparticles. Monodispersity is generally characterized by a low coefficient of variation (or variance), defined as the quotient of the standard deviation on the size distribution divided by the average particle size. In various embodiments, the metal nanoparticles may be homogeneously distributed on a surface of the solid support. At the same time, it may be monodispersed in the sense that size of the metal nanoparticles may be substantially the same. Monodispersity of the nanoparticles is often expressed as a percentage. In various embodiments, the metal nanoparticles have a size variation or a variance value of less than 10%, such as less than 8%, less than 6%, less than 5%, less than 4%, or less than 3%.

The metal nanoparticles may have a surface density in the range from 80 ng cm⁻² to 900 ng cm⁻² on the solid support. By the term “surface density”, this refers to mass per unit surface of the metal nanoparticles on the solid support. In various embodiments, surface density of the metal nanoparticles on the solid support may be in the range from 80 ng cm⁻² to 900 ng cm⁻², such as 100 ng cm⁻² to 900 ng cm⁻², 200 ng cm⁻² to 900 ng cm⁻², 300 ng cm⁻² to 900 ng cm⁻², 400 ng cm⁻² to 900 ng cm⁻², 500 ng cm⁻² to 900 ng cm⁻², 600 ng cm⁻² to 900 ng cm⁻², 700 ng cm⁻² to 900 ng cm⁻², 80 ng cm⁻² to 800 ng cm⁻², 80 ng cm⁻² to 700 ng cm⁻², 80 ng cm⁻² to 600 ng cm⁻², 80 ng cm⁻² to 500 ng cm⁻², 80 ng cm⁻² to 400 ng cm⁻², 80 ng cm⁻² to 300 ng cm⁻², 80 ng cm⁻² to 200 ng cm⁻², 100 ng cm⁻² to 800 ng cm⁻², 200 ng cm⁻² to 800 ng cm⁻², 200 ng cm⁻² to 700 ng cm⁻², or 250 ng cm⁻² to 650 ng cm⁻².

As disclosed herein, a porous layer comprising amorphous hafnium oxide may be disposed on the metal nanoparticles. Amorphous hafnium oxide may advantageously be used as it is the most stable, particularly when in an electrochemical environment, whereas other materials may not be able to sustain harsh conditions of the electrochemical environment.

The porous layer comprising amorphous hafnium oxide may have a thickness in the range from 5 nm to 10 nm. For example, the porous layer comprising amorphous hafnium oxide may have a thickness in the range from 6 nm to 10 nm, 7 nm to 10 nm, 8 nm to 10 nm, 5 nm to 9 nm, 5 nm to 8 nm, 6 nm to 9 nm, or 6 nm to 8 nm.

The porous layer comprising amorphous hafnium oxide may be nanoporous. By the term “nanoporous”, this means that the porous layer may have an average pore diameter or average pore size of up to 100 nm. For example, average pore size of the pores in the porous layer may be in the range from 1 nm to 100 nm, 10 nm to 100 nm, 20 nm to 100 nm, 30 nm to 100 nm, 50 nm to 100 nm, 60 nm to 100 nm, 70 nm to 100 nm, 1 nm to 90 nm, 1 nm to 80 nm, 1 nm to 70 nm, 1 nm to 60 nm, 1 nm to 50 nm, 1 nm to 40 nm, 10 nm to 90 nm, 20 nm to 80 nm, or 30 nm to 60 nm.

The solid support may be a carbon-based material. Carbon-based material may advantageously be used due to their low-cost and high specific area. For example, the solid support may be selected from the group consisting of graphene and carbon paper. In various embodiments, the solid support is graphene.

Various embodiments refer in a second aspect to a method of preparing a catalyst, the method comprising forming metal nanoparticles as active phase on a solid support, and disposing a porous layer comprising amorphous hafnium oxide on the metal nanoparticles.

Examples of suitable metal nanoparticles and solid support have already been mentioned above.

In various embodiments, forming the metal nanoparticles comprises using electron beam evaporation to deposit atoms, nanoclusters, or both atoms and nanoclusters of the metal on the solid support.

The electron beam evaporation may be carried out with temperature of the solid support in the range from 12° C. to 14° C., such as from 13° C. to 14° C. or 12° C. to 13° C., or about 12.5° C., 12.8° C., 13° C., 13.2° C., or 13.5° C.

The electron beam evaporation may be carried out at a pressure in the range from 1×10⁻⁹ torr to 1×10⁻⁸ torr, such as 1×10⁻⁹ torr to 5×10⁻⁹ torr, 5×10⁻⁹ torr to 1×10⁻⁸ torr, or about 5×10⁻⁹ torr.

In various embodiments, the electron beam evaporation is carried out at a deposition rate of 0.1 Å/s for a time period in the range from 10 s to 100 s. The time period may be adjusted to a suitable duration depending on the size of the metal nanoparticles to be formed. Examples of time period may be in the range from 20 s to 100 s, 30 s to 100 s, 40 s to 100 s, 50 s to 100 s, 60 s to 100 s, 70 s to 100 s, 10 s to 90 s, 10 s to 80 s, 10 s to 70 s, 10 s to 60 s, 10 s to 50 s, 10 s to 40 s, 20 s to 80 s, 30 s to 70 s, or 40 s to 60 s.

In various embodiments, the method further comprises subjecting the solid support having the atoms, nanoclusters, or both atoms and nanoclusters of the metal disposed thereon to a temperature of 250° C. or less to allow the atoms, nanoclusters, or both atoms and nanoclusters of the metal to coalesce and form the metal nanoparticles on the solid support.

In various embodiments, disposing the porous layer comprising amorphous hafnium oxide on the metal nanoparticles is carried out while the metal nanoparticles are being formed on the solid support.

For example, solid support comprising the atoms, nanoclusters, or both atoms and nanoclusters of the metal following electron beam evaporation may be subjected to a temperature of 250° C. or less, while a porous layer comprising amorphous hafnium oxide may be formed and/or disposed on the metal nanoparticles. Accordingly, while the atoms, nanoclusters, or both atoms and nanoclusters of the metal coalesce and form the metal nanoparticles on the solid support, the porous layer comprising amorphous hafnium oxide may be formed and/or disposed on the metal nanoparticles.

In various embodiments, disposing the porous layer comprising amorphous hafnium oxide on the metal nanoparticles comprises atomic layer deposition of a hafnium precursor and an oxygen precursor in alternating sequence at a temperature of 250° C. or less.

The atomic layer deposition may, for example, be carried out at a temperature of 200° C. or less, 150° C. or less, or a temperature in the range from 150° C. to 250° C., 180° C. to 250° C., 200° C. to 250° C., 150° C. to 220° C., 150° C. to 200° C., or 180° C. to 220° C. In various embodiments, disposing the porous layer comprising amorphous hafnium oxide on the metal nanoparticles comprises atomic layer deposition of a hafnium precursor and an oxygen precursor in alternating sequence at a temperature of 250° C.

The term “precursor” as used herein refers to a compound that may be treated or further processed to form the target material. Accordingly, the terms “hafnium precursor” and “oxygen precursor” may refer to compounds that may be further processed to form hafnium and oxygen, respectively.

The hafnium precursor may, for example, be [(CH₃)₂N]₄Hf.

The oxygen precursor may, for example, be water.

By the term “alternating sequence”, this means to interchange repeatedly. For example, a hafnium precursor may first be introduced via atomic layer deposition to the metal nanoparticles, followed by the oxygen precursor. This may make up one cycle of atomic layer deposition. The sequence may be repeated for one or more cycles, depending on the number of cycles of the atomic layer deposition.

For example, the atomic layer deposition may be carried out for a number of cycles in the range from 50 cycles to 100 cycles, such as 60 cycles to 100 cycles, 70 cycles to 100 cycles, 80 cycles to 100 cycles, 50 cycles to 90 cycles, 50 cycles to 80 cycles, 50 cycles to 70 cycles, 60 cycles to 90 cycles, or 70 cycles to 80 cycles.

The atomic layer deposition may be carried out with exposure time of the hafnium precursor and the oxygen precursor being independently selected from the range of 0.1 s to 0.5 s, respectively. For example, the exposure time may be in the range of 0.2 s to 0.5 s, 0.3 s to 0.5 s, 0.1 s to 0.4 s, 0.1 s to 0.3 s, or 0.2 s to 0.4 s. Alternatively, or in addition to the above, the atomic layer deposition may be carried out with waiting time for the reaction of the hafnium precursor and the oxygen precursor in the range of 3 s to 8 s. In other words, the waiting time may be set at a suitable time period to allow reaction of the hafnium precursor and the oxygen precursor to take place, which may for example, be in the range of 4 s to 8 s, 5s to 8 s, 6 s to 8 s, 3 s to 7 s, 3 s to 6 s, 3 s to 5 s, 4 s to 7 s, 4 s to 6 s, or 5 s to 7 s.

Various embodiments refer in a third aspect to use of the catalyst according to the first aspect or prepared by a method according to the second aspect in electrode, proton exchange membrane water electrolyzer, or fuel cell.

In order that the invention may be readily understood and put into practical effect, particular embodiments will now be described by way of the following non-limiting examples.

### EXAMPLES

Various embodiments relate to capping strategy to extend the stability of ultra-low loading metal-based electrocatalysts, and more specifically to supported submonolayer metal electrocatalysts with ultra-low loading for hydrogen evolution in proton exchange membrane (PEM) water electrolyzer, in one embodiment, the electrocatalysts being protected submonolayer platinum nanoparticles (NPs) on large-scale carbon substrates.

Embodiments herein relate to surface overcoating strategies to prevent the sintering/dissolution of underlying metal nanospecies. Effective structural stabilization for metal nanoparticles, exceptional corrosion resistance, decent thermal stability, good electrochemical accessibility and large-scale production capability may be achieved by catalysts according to embodiments disclosed herein. Advantageously, in embodiments whereby Pt is used, Pt loading may be reduced significantly, which in turn reduces costs. The accelerated global hydrogen fueling market requires minimizing Pt loading from current 0.5-1.0 mg cm⁻² to several μg cm⁻². Methods disclosed herein are able to reduce the PEM water electrolyzer's current Pt usage to 81.39 ng cm⁻² on graphene, and 809.07 ng cm⁻² on carbon paper.

Other advantages may relate to improved intrinsic activity, namely, high mass activity and turn over frequency (TOF). Specifically, 10 nm m-HfO₂@Pt_{0.1nm} on graphene exhibit mass activity of 122.87 A mg⁻¹ at 10 mA cm⁻² under overpotential of 11 mV, and TOF of 1939.412 s⁻¹ under overpotential of 100 mV; 10 nm m-HfO₂@Pt₁ₙₘ on carbon paper demonstrate mass activity of 12.36 A mg⁻¹ at specific activity of 10 mA cm⁻² under overpotential of 59 mV, and TOF of 25.62 s⁻¹ under overpotential of 100 mV.

Further advantages may relate to the remarkably enhanced durability of supported Pt NPs catalyst with ultralow loading for PEM water electrolyzer. For instance, after consecutively cycling the catalyst for 93 hrs at 10 mA cm⁻², 22 hrs at 20 mA cm⁻², and 23 hrs at 40 mA cm⁻², the 10 nm m-HfO₂@Pt₁ₙₘ on carbon paper showed no loss of specific activity. This is due to the m-HfO₂ capping layer having good rigidity, excellent thermal stability, high anti-corrosion properties in all pH solution, and strong metal-support interaction (SMSI). Besides, this holey m-HfO₂ cover layer has good proton conductivity due to the abundant hole structures serving as proton-conducting and H₂ transport nanochannels.

### Example: Synthesis and Characterization of m-HfO₂@ M Nanoparticles

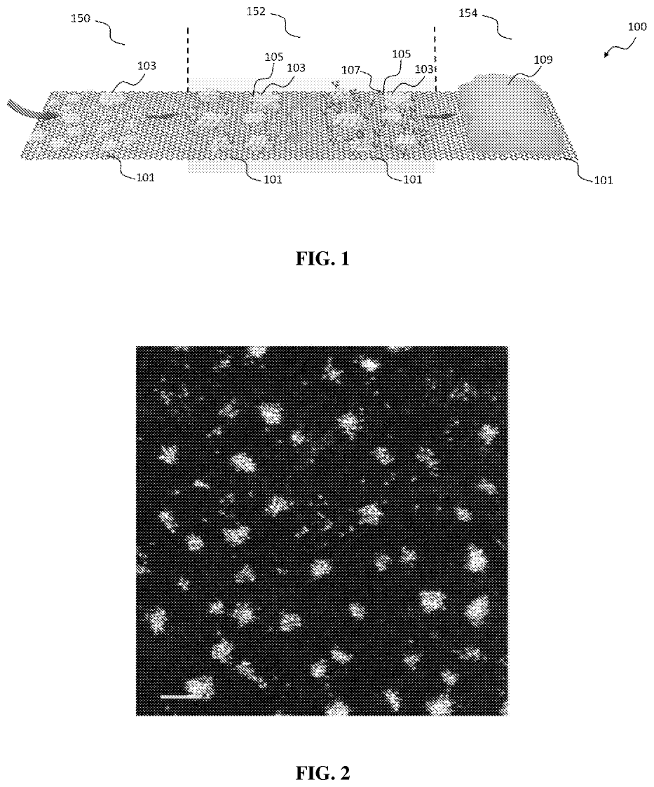

An atomic layer co-deposition method was developed to fabricate m-HfO₂@ M nanoparticles on a large-scale support (up to 3 cm by 3 cm) with an atomically precise manner (FIG. 1).

To ensure homogenous and dense distribution of isolated metal nanospecies, low-rate e-beam evaporation was employed to deposited submonolayer single metal atoms/nanoclusters at a rate of 0.1 Å/s for 10 s (FIG. 2).

M as Pt was used, on wafer-scale. First, submonolayered Pt single atoms/nanoclusters with controlled size were deposited on supports (CVD-graphene, carbon paper, titanium mesh) by low-rate e-beam evaporation at 0.1 Å s⁻¹ under a low temperature of 12° C.

In embodiments, the low-rate e-beam evaporation was carried out in a low-rate electron beam evaporation (E-beam) chamber (ATC Orion-8E). This technique features precise control on the amount of deposited Pt and an extremely low degree of contamination. The Pt_{0.1nm} on graphene and Pt₁ₙₘ on carbon paper were obtained at a rate of 0.1 Å/s for 10 s and 100 s, respectively. The low substrate deposition temperature (14° C.) and ultra-high vacuum pressure (5*10⁻⁹ torr) ensure the prohibition of atom aggregation and strong adhesion between metal atoms and the support.

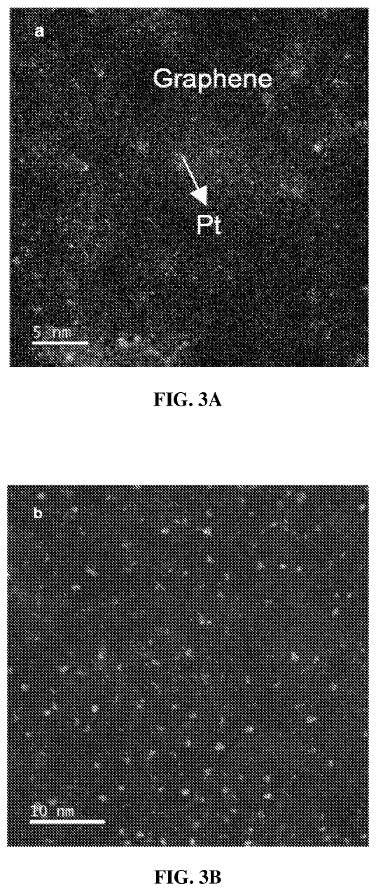

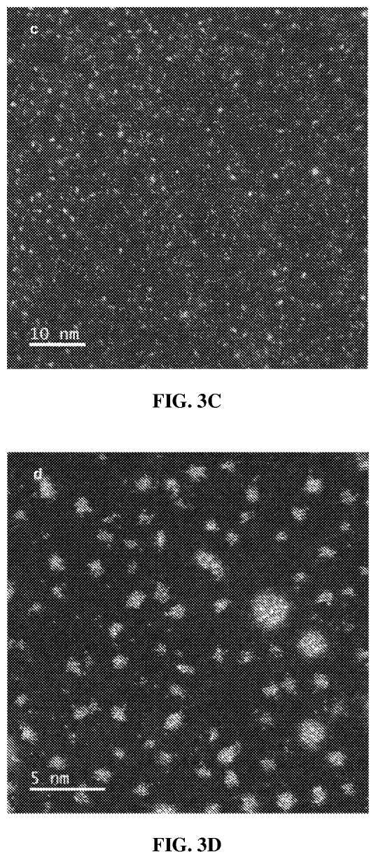

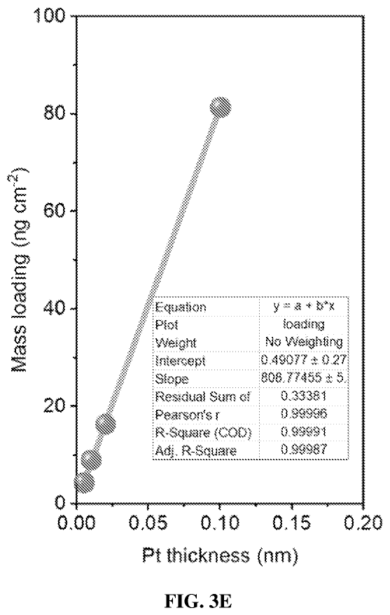

FIG. 3A to FIG. 3E shows the uniform distribution of just evaporated Pt atoms onto graphene with different deposition times. The mass loading of Pt for different samples is determined by mapping the Pt atoms in the corresponding STEM images (FIG. 3A to FIG. 3D). The average mass loading for specific Pt thickness is exhibited in FIG. 3E. The mass loading displays a positive linear correlation with the deposited Pt thickness, implying the stable and precise deposition rate. The STEM counting verifies that the average Pt mass loading of Pt_{0.1nm} is 81.39 ng cm⁻² (FIG. 3E).

Next, atomic layer deposition (ALD) was employed to deposit amorphous HfO₂ capping layer onto the supported Pt atoms/nanoclusters. During the growth process, m-HfO₂ thin film grows in a cycle manner. Two chemical precursors of Hf precursor and O precursor, namely [(CH₃)₂N]₄Hf and H₂O (Strem Chemicals), were alternatively exposed to the substrate under 250° C. The deposition temperature was set to 250° C. to avoid agglomeration of adjacent Pt NPs.

The reaction time (waiting time) was set to be 5 s to construct the porous HfO₂ structure. In all embodiments for forming amorphous porous HfO₂, supported Pt nanoclusters on carbon paper or graphene were alternatively subjected to the two chemical precursors, [(CH₃)₂N]₄Hf and H₂O, with exposure time of 0.3 s and 0.25 s, respectively, and waiting time of 5 s.

Given the self-limiting growth nature of ALD process, it was possible to precisely control the deposition thickness in nanoscale by varying the number of growth cycles. For example, one atomic-layer HfO₂ may be deposited on supported Pt_{0.1nm} nanoclusters during one ALD cycle. By varying the cycling number, the thickness of m-HfO₂ layer can be controlled in nanoscale. In embodiments, 10 nm m-HfO₂@Pt_{0.1nm} on graphene and 10 nm m-HfO₂@Pt₁ₙₘ on carbon paper were achieved with 100 ALD cycles.

The fabrication method can be generalized to protecting other metal/alloy nanoparticle systems for various implications. It will be appreciated to note that both E-beam and ALD techniques are capable for the scalable and precious synthesis of Xₘ—HfO₂@M_{Y} NPs for industrial usage.

### Example: Structure Characterization Method

The morphology and atomic-structures of m-HfO₂@Pt nanoparticles were characterized by annular dark-field scanning transmission electron microscopy (ADF-STEM) imaging (JEOL ARM200F). The interface between Pt and m-HfO₂ will be revealed by cross-section STEM. The chemical analysis was performed by WITEC alpha 200R Confocal Raman system with a 532 nm laser. The X-ray photoelectron spectroscopy (XPS) was employed to detect the chemical state and detailed coordinative environment of Pt, Hf, C, and O.

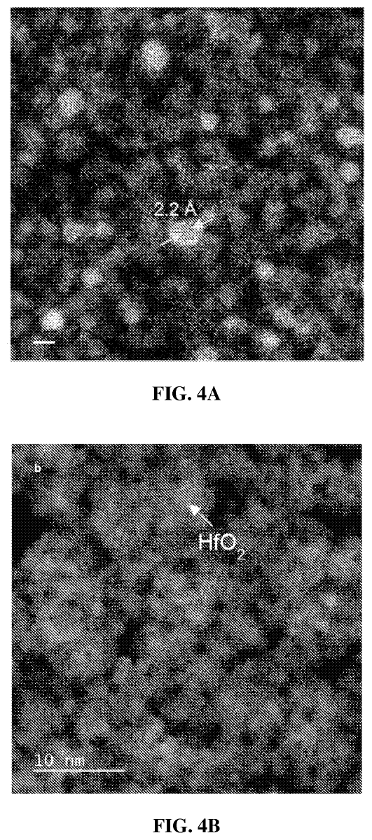

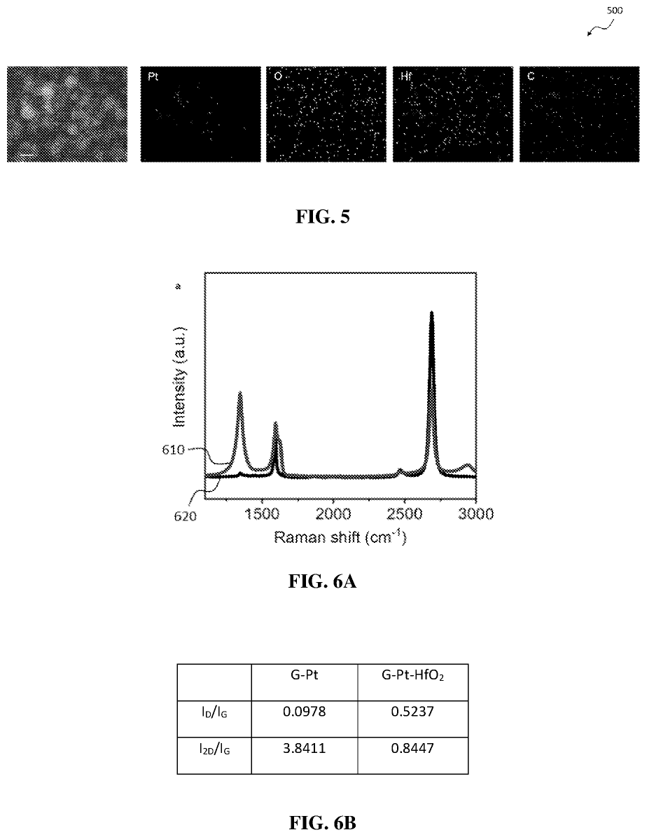

As shown in the high-angle annular dark-field scanning transmission electron microscopy (HAADF-STEM) image (FIG. 4A), such pre-deposited species not only serve as nucleation sites for the atomic layer deposition of amorphous HfO₂, but also tend to aggregate and crystallize into small nanoparticles under 250° C. FIG. 4A and FIG. 4B depict the structure of resulting m-HfO₂@Pt nanoparticles with m-HfO₂ in thickness of 3 nm and 10 nm, respectively. Notably, nanoholes are present in both samples, suggesting that the reactants and products can easily permeate through the overlayer and reach to/detach from Pt nanoparticles. Besides, well-dispersed Pt nanoparticles possess a unform size with diameter in 2-3 nm, as shown in FIG. 4A. In contrast, Pt nanoparticles are invisible in FIG. 4B, suggesting that they are completely embedded beneath 10 nm m-HfO₂. Cross-section STEM image further confirm that m-HfO₂ fully wrapped the underlaying Pt nanoparticles, firmly anchoring onto probably with covalent bonding at the Pt-HfO₂ interface (FIG. 5).

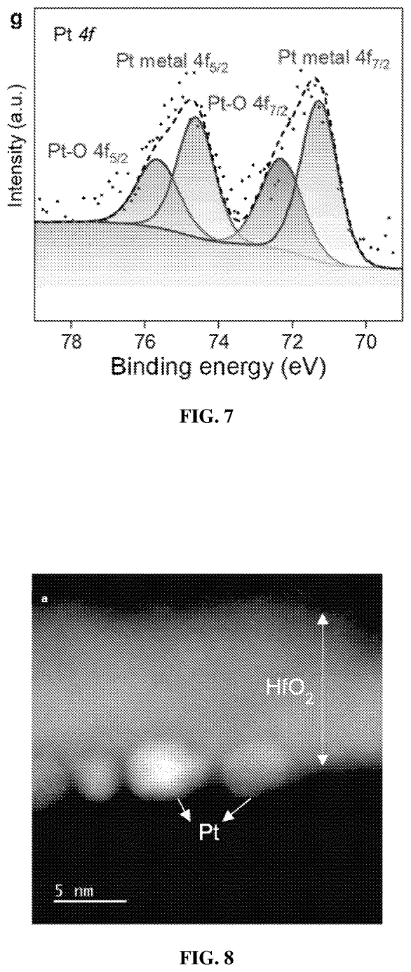

To examine the chemical bonding, Raman and XPS analysis were performed. Raman spectra demonstrate the dramatically increased D peak and emergence of D′ peak due to the broken graphene lattice symmetry by the structural defects (FIG. 6A and FIG. 6B). Moreover, the intensity ratio of I_{D}/I_{G} (I_{2D}/I_{G}) increase (decrease) from 0.0978 to 0.5237 (3.8411 to 0.8447), indicating that the pristine highly crystalline CVD-grown monolayer graphene presents a certain degree of disorder after growth of m-HfO₂. This might be due to the nucleation and growth of HfO₂ onto graphene. The XPS spectra of Pt (FIG. 7) shows the definite partial Pt (I) feature and metallic Pt (0) with a ratio of about 1:2, indicating Pt—O bonding at Pt nanoparticles interface (FIG. 8). FIG. 8 also depicts the structure of as-prepared 10 nm m-HfO2@Pt0.1 nm. The cross-section STEM image in FIG. 8 clearly shows that m-HfO₂ fully wrapped the underlaying Pt nanoparticles, firmly anchoring Pt nanoparticles onto graphene. Besides, Pt nanoparticles possess a uniform size with a diameter of 2-3 nm.

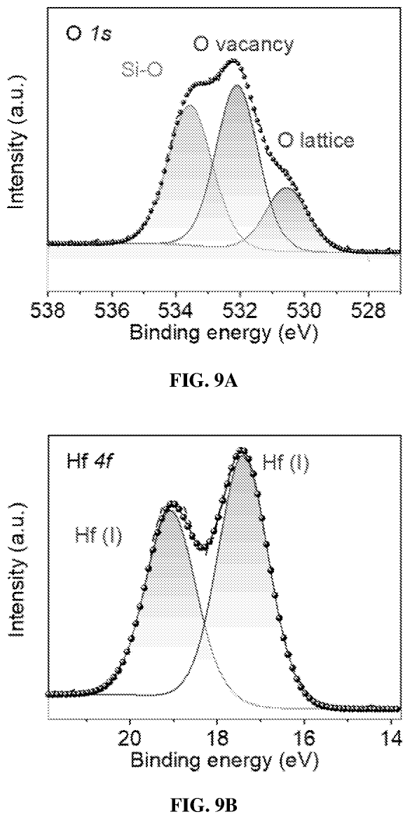

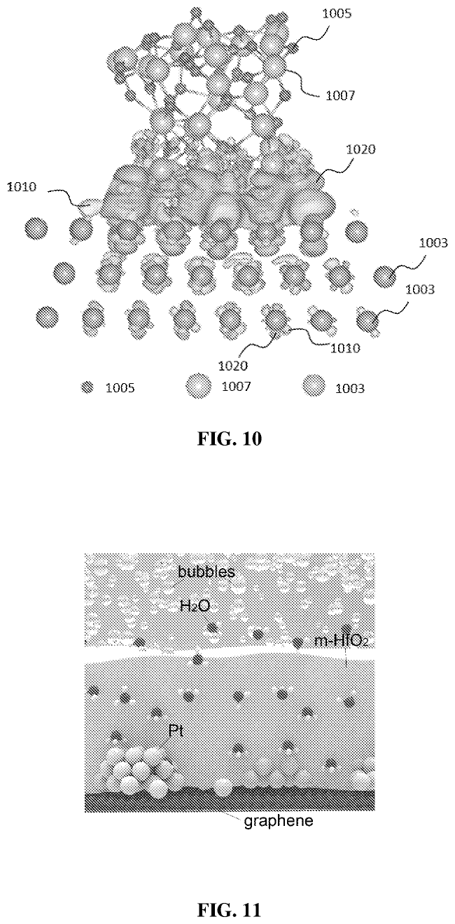

The oxygen 1 s peak was deconvoluted into three peaks, centered at 530.5, 532.1, and 533.6 eV, respectively (FIG. 9A and FIG. 9B). The first peak corresponded to Hf-O, the second to Hf—OH, and the last one to Si—O from the SiO₂/Si substrate. Notably, this enriched hydroxyl group suggest that m-HfO₂ overlayer not only could capture proton but can serve as proton reservoirs in the HER reaction. To examine the potential interaction between nanoparticles and capping layer, the charge density distribution of m-HfO₂@Pt nanoparticle was further investigated (FIG. 10). Although a real m-HfO₂ structure may not be simulated, this aim to shed light on the metal (Pt)-support (m-HfO₂) interaction.

For purpose of charge density difference calculation, charge density difference map is generally utilized to visualize the redistribution of charges in a heterostructure. By calculating and analyzing the differential charge density, valuable insights into charge movement and the direction of bonding polarization during bonding and electronic coupling process can be obtained. The definition formula of differential charge density in FIG. 10 is as follows:

$$Δρ = {ρ}_{m - {HfO}_{2} @ Pt} - {ρ}_{m - {HfO}_{2}} - {ρ}_{Pt}$$

where ρ_{m-HfO}_{₂}_{@Pt} is the charge density of the entire system, ρ_{m-HfO}_{₂} is the charge density of the m-HfO₂ layer, and ρ_{Pt} is the charge density of the perfect Pt nanoparticle.

Interface m-HfO₂ contribute substantial electrons to surface Pt layer, demonstrating the electron-transfer process occurs at the interface and further strong metal-support interactions.

### Example: Ion Penetration Depth and Ion Conductivity Measurement

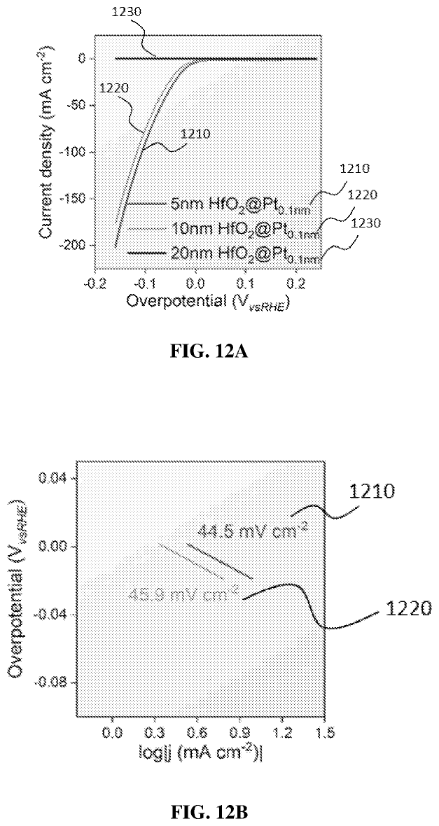

Owing to the abundant nanopores in the m-HfO₂ film, the reactants and products can be transferred to/from active sites under electrochemical/concentration potential (FIG. 11). However, the interconnected transport channels probably be blocked in thicker m-HfO₂ layer. Therefore, m-HfO₂@Pt_{0.1nm} on graphene with varied m-HfO₂ thickness were fabricated, and the ion penetration depth as well as product diffusion length using micro-cell devices were examined (FIG. 12A).

In carrying out investigation of the activity and durability of m-HfO₂ capped nanoparticles towards HER and OER, the activity and durability of as-prepared catalysts in both the micro-scale and macro-scale were evaluated. In micro-scale, well-defined graphene supported m-HfO₂@Pt were fabricated and the proton conductivity, HER and OER activity were tested using the on-chip microflow cell (home-made micro electrochemical system with a current resolution of 10⁻¹²A) in Ar saturated 0.5M H₂SO₄ and or O₂-saturated 1M KOH, respectively. The saturated Ag/AgCl and Hg/HgO was used as the reference electrode in acidic and alkaline solution, respectively, and the graphite rod served as the counter electrode instead of Pt foil to exclude the potential Pt deposition from the counter electrode. In macro-scale, a typical H cell setup was assembled to evaluate the durability of large-scale carbon paper supported m-HfO₂@Pt in a real working environment. To eliminate carbon redeposition on working electrode, carbon rod as the counter electrode is separated by Nafion 117 membrane from working and reference electrodes.

As shown in FIG. 12A and FIG. 12B, the 5 nm, and 10 nm m-HfO₂ coated materials exhibit similar HER activities, while the 20 nm counterpart shows negligible activity, suggesting nanochannels might be blocked when further increasing the thickness to 20 nm. To ensure sufficient proton transport and effective protection, 10 nm m-HfO₂ cover layer was chosen for the following electrochemical tests.

Electrochemical characterization of the 10 nm m-HfO₂@Pt_{0.1nm} on graphene was tested in a homemade 3-electrode microelectrochemical system, while that of the 10 nm m-HfO₂@Pt₁ₙₘ on carbon paper was tested in a traditional 3-electrode system (Biologic SVP).

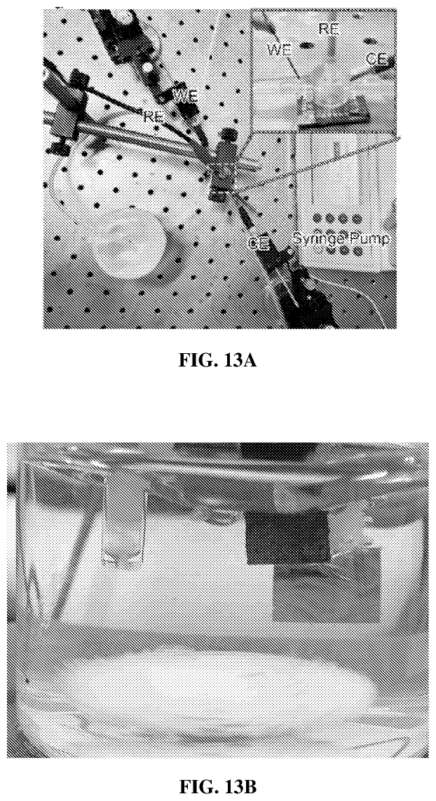

A micro-flow cell was designed and employed to examine the stability of 10 nm m-HfO₂@Pt_{0.1nm} on graphene (FIG. 13A).

As demonstrated in FIG. 13A, in the microelectrochemical system, 10 nm m-HfO₂@Pt_{0.1nm} on graphene is the working electrode, with a carbon rod (Ted Pella) as the counter electrode, leakless Ag/AgCl electrode (EDAQ) as reference electrode, and 0.5M H₂SO₄ (Honeywell) as electrolyte. In the traditional 3-electrode system of FIG. 13B, 10 nm m-HfO₂@Pt₁ₙₘ on carbon paper is the working electrode, with Pt foil as the counter electrode, Ag/AgCl electrode (Metrohm Autolab) as the reference electrode, and 0.5M H₂SO₄ (Honeywell) as electrolyte (FIG. 13B). In both cases, the potential of Ag/AgCl was pre-measured in a 2-electrode system with respect to a standard hydrogen electrode (EDAQ).

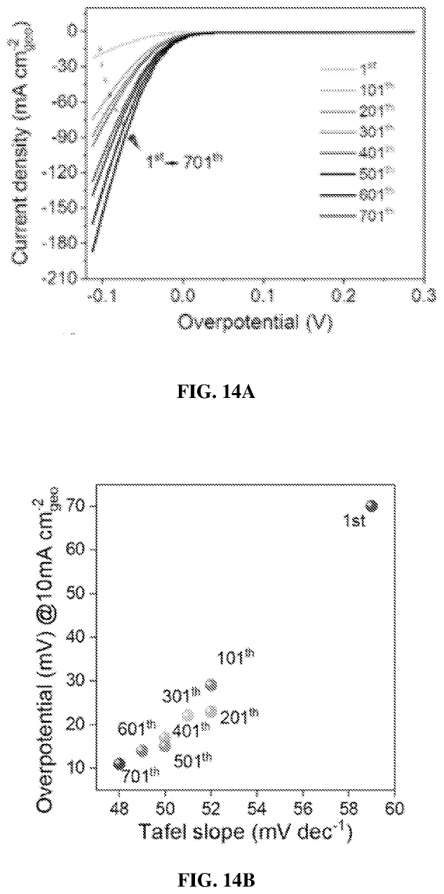

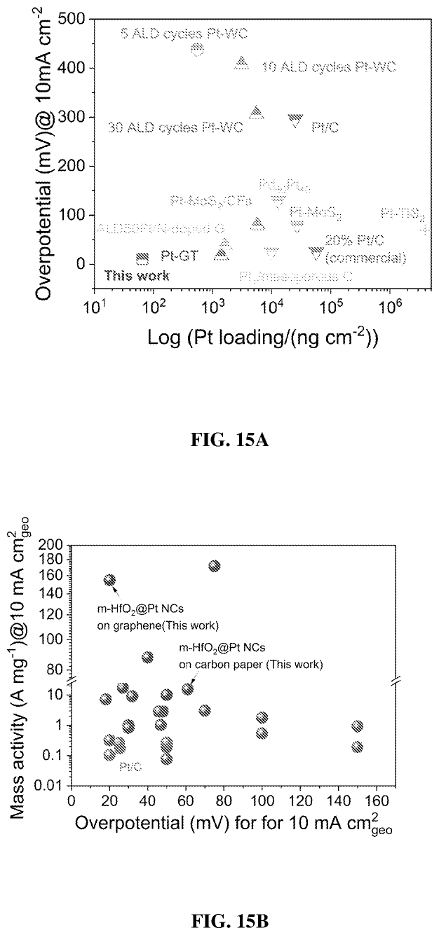

In the case of 10 nm m-HfO₂@Pt_{0.1nm} on graphene, the continuous linear sweep voltammetry (LSV) showed enhanced activities with smaller overpotential at 10 mA cm⁻² and smaller Tafel slope during continuous cycling, suggesting the excellent stability and activity under acidic working conditions (FIG. 14A and FIG. 14B). The overpotential required to obtain a current density of 10 mA cm⁻² was only 11 mV after 700 cycles. FIG. 15A and FIG. 15B show the comparison of loading mount, mass activities, and overpotential for materials disclosed herein against state-of-art Pt-based materials. Notably, 10 nm m-HfO₂@Pt_{0.1nm} on graphene as disclosed herein exhibited the smallest loading (81.39 ng cm⁻², FIG. 3A to FIG. 3E), the best mass activities (122.87 A mg⁻¹), and the lowest overpotential (11 mV), simultaneously. Besides, 10 nm m-HfO₂@Pt₁ₙₘ on carbon paper shows a decent performance with mass loading of 809.07 ng cm⁻², mass activities of 12.36 A mg⁻¹ at a current density of 10 mA cm⁻².

### Example: On-Chip Microcell Fabrication Process

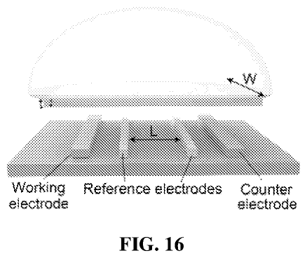

Furthermore, an on-chip four-electrode cell was fabricated and employed to measure proton conductivity of m-HfO₂ film by measuring the ohmic resistance (FIG. 16).

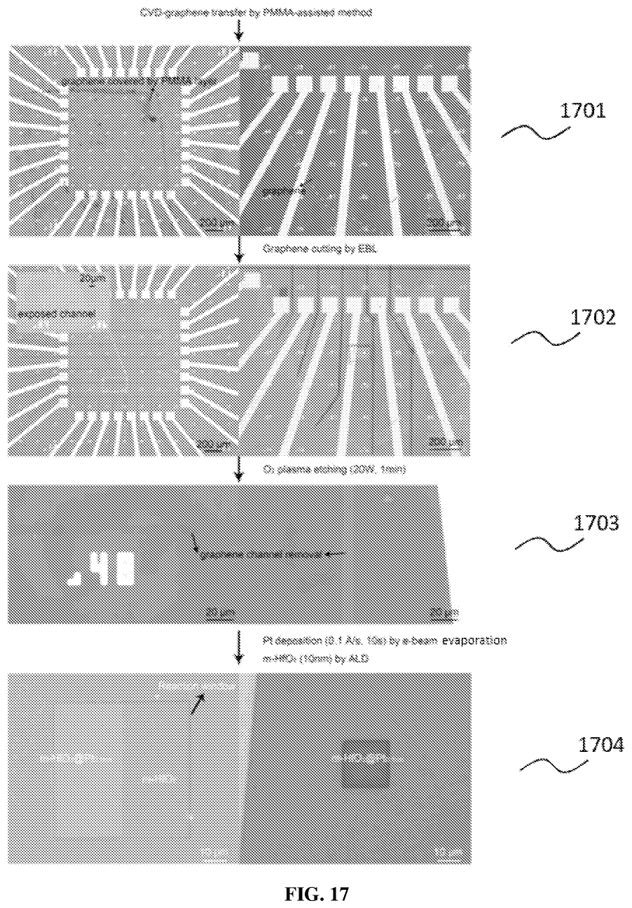

A typical fabrication of an on-chip device disclosed herein involved five major steps (FIG. 17). Firstly, conventional photolithography and e-beam evaporation were employed to pre-pattern 5 nm thick Ti/50 nm thick Au contact pads on SiO₂/Si substrates or transparent glass substrates. Next, CVD-grown monolayer graphene film was transferred onto the on-chip devices by standard PMMA-assisted method. As a further step, to disconnect adjacent electrodes, e-beam lithography (EBL) and O₂ plasma (20W, 1 min) were employed to remove selected graphene channels. Next, well-controlled m-HfO₂@Pt were synthesized on graphene via aforementioned methods. Further, the reaction windows were exposed on selected area by EBL in 1-μm-thick PMMA protection film, ensuring that the reaction only occurred in the region of interest.

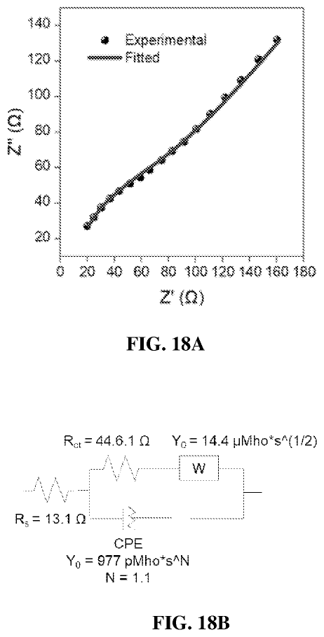

Prior to electrochemical impedance spectroscopy (EIS) test, in order to fill the film with H⁺ ions, the device was immersed in 2M H₂SO₄ for 24 hours and then in deionized water for 24 hours, respectively. The proton conductivity (σ) can be determined by σ=L/(RWT), where L, W, and T is distance between reference electrodes (2.86 μm), the width (10.25 μm), and thickness (10 nm), respectively, and R denotes resistance which can obtain from Nyquist plot (FIG. 18A and FIG. 18B) to be 13.1Ω. As a result, the m-HfO₂ film shows high proton conductivity with a value of 2.13×10⁴ mS cm⁻¹.

### Example: In-Situ Observation of Bubble Nucleation and Growth

To examine the bubble nucleation sites for 10 nm m-HfO₂@Pt_{0.1nm} on graphene and whether bubble evolution will cause perforation of m-HfO₂ film, an inverted optical microscopy (60 frames per second, spatial resolution 260 nm pix⁻¹) was combined with a transparent on-chip electrochemical micro-cell device.

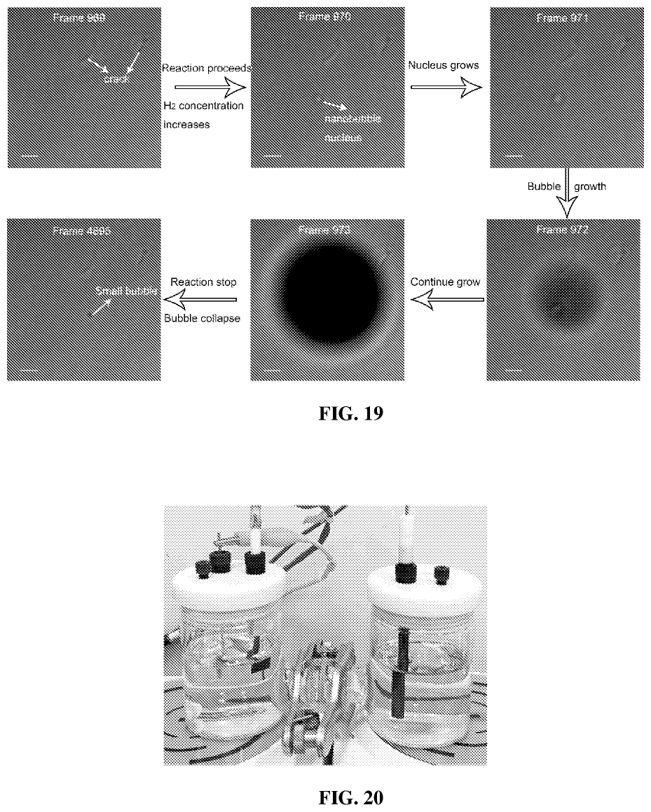

FIG. 19 shows an example of bubble evolution during linear sweep voltammetry (LSV) and further without applied potential. The set of images tracks the temporal evolution of a bubble from nucleation, growth to collapse. Within 16.7 ms from frame 696 to 670, a single hydrogen bubble with a diameter of about 500 nm was visible on the device. The further bubble growth from frame 970 to 973 was mainly governed by Henry's law, as local H₂ concentration in aqueous solution continuously increased driven by higher overpotential. After LSV, the micro-sized bubble graduate shrunk to a nanobubble with a diameter of about 260 nm. It was evidenced that the nucleation and growth of H₂ bubble did not result in structure damage of capping layer, demonstrating that H₂ molecule diffused through m-HfO₂ away from Pt active sites and finally formed bubbles on m-HfO₂ surface. Therefore, the capping layer was able to serve as efficient mass transport channel and avoid blockage of active site due to bubble formation.

### Example: Macro-Cell Measurements

To further evaluate the effectiveness of capping strategies and lower cost, a commercial carbon paper was used as the substrate. Pt nanoparticles and m-HfO₂ capping layer were directly deposited onto it, and its performance was further evaluated in a H-cell configuration (FIG. 20).

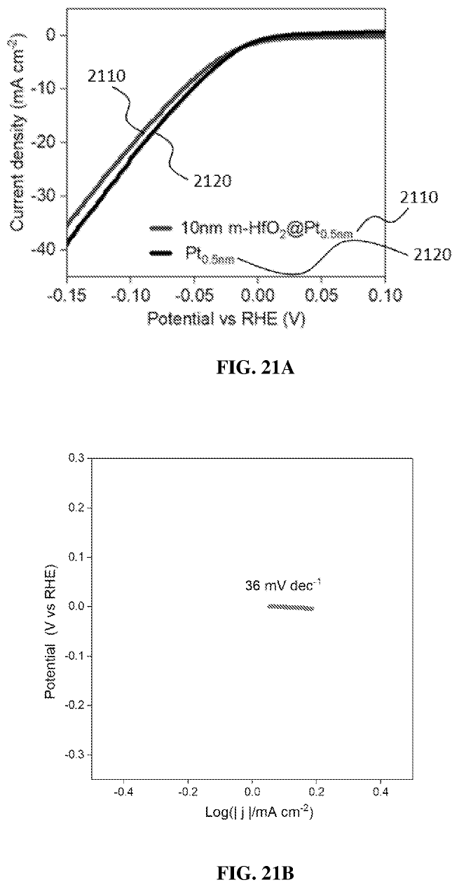

As shown in FIG. 21A and FIG. 21B, 10 nm m-HfO₂@Pt_{0.5nm} on carbon paper displayed overpotential at 10 mA cm⁻² of 59 mV, and a Tafel slope of 35 mV dec⁻¹. Besides, 10 nm m-HfO₂@Pt_{0.5nm} on carbon paper showed a decent performance with mass loading of 404.54 ng cm⁻², mass activities of 24.72 A mg⁻¹ at a current density of 10 mA cm⁻².

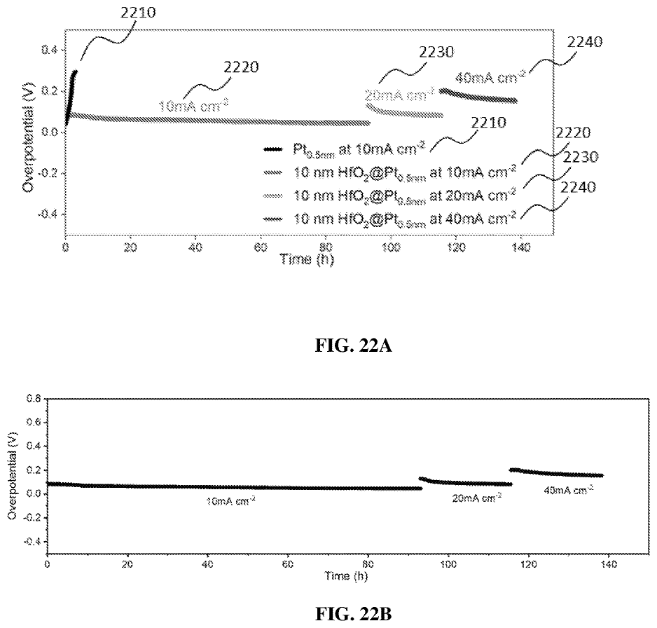

Furthermore, consecutive galvanostatic measurements was conducted at a current density of 10 mA cm⁻², 20 mA cm⁻², and 40 mA cm⁻² for 10 nm m-HfO₂@Pt_{0.5nm} on carbon paper. As a result, the material exhibited superb stability during successive operation for 93 hrs at 10 mA cm⁻², 22 hrs at 20 mA cm⁻², and 23 hrs at 40 mA cm⁻² (FIG. 22A). This significantly extended lifetime may be ascribed to intrinsic properties of the m-HfO₂ capping layer, including the good rigidity, excellent thermal stability, high anti-corrosion properties in all pH solution, and strong metal-support interaction (SMSI). In contrast, without protection layer, Pt_{0.5nm} on carbon paper degrade significantly within 2 hours at 10 mA cm⁻².

Consecutive galvanostatic measurements at a current density of 10 mA cm⁻², 20 mA cm⁻², and 40 mA cm⁻² were also carried out for 10 nm m-HfO₂@Pt₁ₙₘ on carbon paper. As shown in FIG. 22B, the material exhibited superb stability during successive operation for 93 hrs at 10 mA cm⁻², 22 hrs at 20 mA cm⁻², and 23 hrs at 40 mA cm⁻². This significantly extended lifetime is ascribed to the intrinsic properties of the m-HfO₂ capping layer, including the good rigidity, excellent thermal stability, high anti-corrosion properties in all pH solution, and strong metal-support interaction (SMSI).

### Example: Thermal Stability

In-situ high-temperature stability characterisation was carried out. To directly observe the behaviour of Pt nanoparticles under high temperature, an in-situ heating experiment in STEM (JEOL ARM200F) was carried out, operated at 200 kV. The as-prepared HfO₂-based material was transferred onto a MEMS micro-heater chip (Fusion thermal E-chips). This microscope allowed high angle annular dark field, annular bright field, and bright field STEM imaging with resolution less than 0.078 nm.

To examine the anti-sintering properties, high-resolution STEM images during ageing at 500° C. and 700° C. were recorded to obtain atomic scale information on possible structural evolution of 3 nm m-HfO₂@Pt_{0.1nm}.

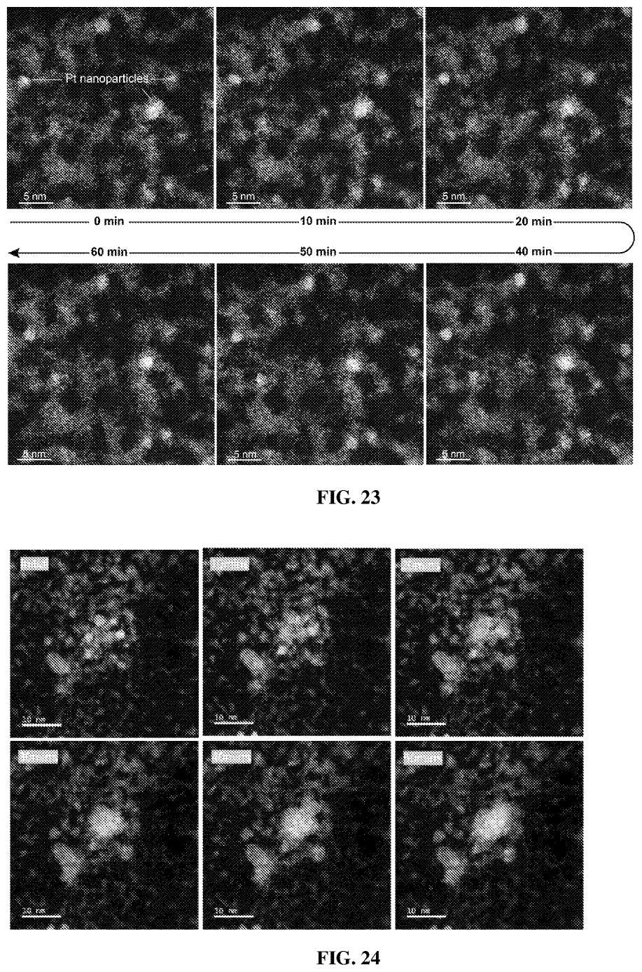

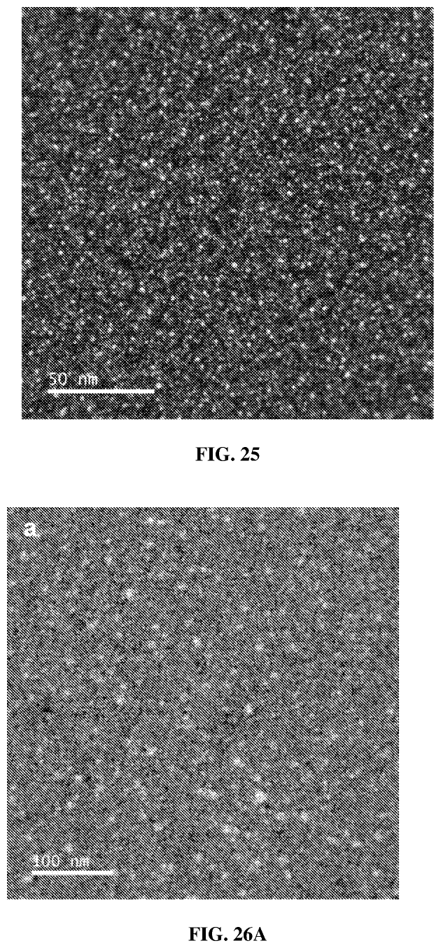

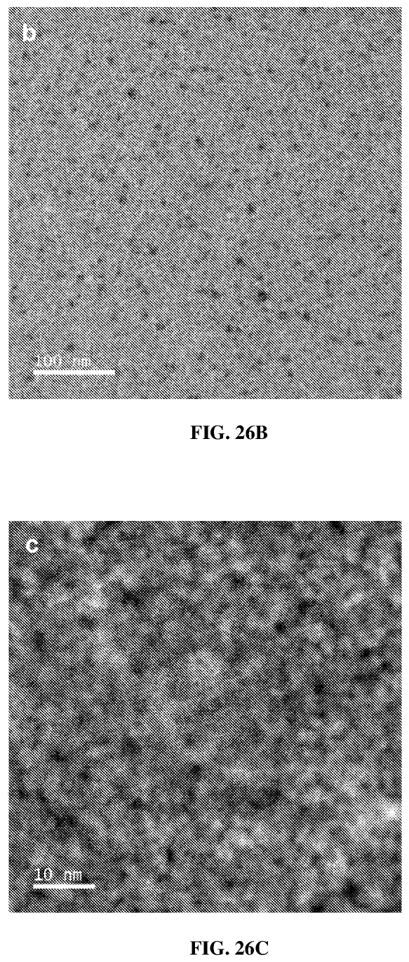

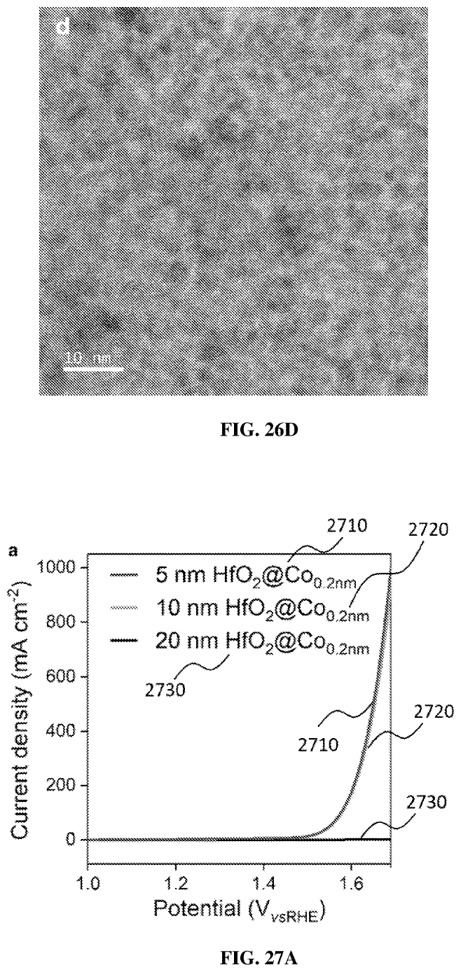

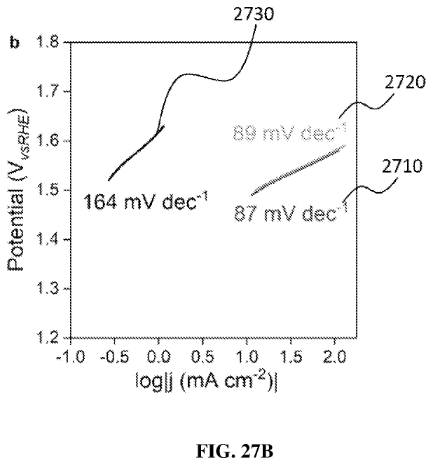

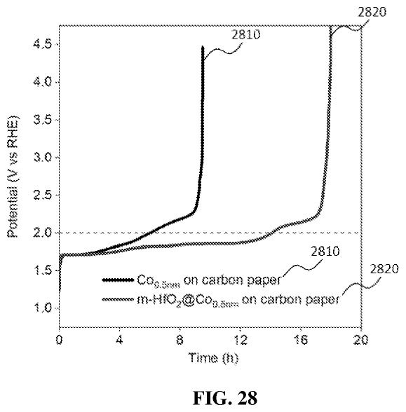

As shown in the snapshots from FIG. 23 (taken from a movie of structural evolution of 3 nm m-HfO₂@Pt_{0.1nm} under in situ TEM heating at 500° C. (Sped up×600) with full sequences, which may be provided upon request), no structural deformation, that is aggregation of Pt nanoparticles or phase change of m-HfO₂, was observed during 1 hr heating at 500° C.; further heating at 700° C., while Pt nanoparticles encapsulated within HfO₂ remained intact, some amorphous domains of the HfO₂ cap layer underwent phase transformations (FIG. 24, taken from a movie of structural evolution of 3 nm m-HfO₂@Pt_{0.1nm} under in situ TEM heating at 700° C. (Sped up×600) with full sequences, which may be provided upon request). These observations indicate that m-HfO₂@Pt NPs disclosed herein demonstrated excellent anti-sintering properties and has potential applications in high temperature catalysts.

### CONCLUSION

In summary, embodiments disclosed herein constructs metal nanoparticle embedded architectures, namely, amorphous HfO₂ (m-HfO₂) sheathed monodispersed metal nanoparticles (X m-HfO₂@ M_{Y}) on large-scale carbon supports. The m-HfO₂ capping layer, with excellent thermal stability and anti-corrosion properties in all pH solution, was employed to firmly anchor the monodispersed metal NPs onto carbon substrates, graphene and carbon paper. By tailoring the thickness of m-HfO₂ and the size of metal NPs in an atomically precise manner, ultra-stable and highly efficient electrocatalysts with Pt loading at tens-hundreds of ng per cm⁻² were realised. Embodiments disclosed herein may effectively addresses the Pt scarcity, cost, and durability issues and may further facilitate the worldwide development of green H₂ economy. Commercial applications of embodiments disclosed herein may include cathode and anode for PEM water electrolyzers and fuel cells

As disclosed herein, a capping strategy for submonolayer metal electrocatalysts with ultrahigh durability and mass activity is provided. The capping strategy disclosed herein is able to provide for electrocatalysts with ultra-low metal loading.

To address activity and durability challenge of electrocatalysts in water electrolyzers and fuel cells, embodiments disclosed herein propose to use rigid porous oxide coverlayer to suppress the degradation of underneath metal species. In embodiments, construction nanosized metal embedded architecture, that is, amorphous HfO₂ (m-HfO₂) sheathed monodispersed metal nanoparticles on large-scale carbon supports, has been demonstrated. This structure is represented by the formula, Xₘ—HfO₂@ M_{Y} NPs, where M may represent nanosized metal species such as Pt, Co, Ni, PtCo alloy, and PtNi alloy, where X and Y are the thickness of m-HfO₂, and the amount of deposited metal species, respectively.

In exemplary embodiments, the composition tested was 10 nm m-HfO₂@Pt_{0.1nm} NPs on graphene and 10 nm m-HfO₂@Pt₁ₙₘ NPs on carbon paper. It will be appreciated that the metal need not necessarily be limited to Pt, but can be any other metals or metal alloys, including Fe, Ni, Pd, Al, Ir, and so forth. Likewise, the amount of deposited metal determines the metal loading of catalyst, further the mass activities, not the durability of the catalysts. It is not restricted to 0.1 nm or 1 nm but can be any value as long as the resulting catalyst has desirable mass activities.

By “comprising” it is meant including, but not limited to, whatever follows the word “comprising”. Thus, use of the term “comprising” indicates that the listed elements are required or mandatory, but that other elements are optional and may or may not be present.

By “consisting of” is meant including, and limited to, whatever follows the phrase “consisting of”. Thus, the phrase “consisting of” indicates that the listed elements are required or mandatory, and that no other elements may be present.

The inventions illustratively described herein may suitably be practiced in the absence of any element or elements, limitation or limitations, not specifically disclosed herein. Thus, for example, the terms “comprising”, “including”, “containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the inventions embodied therein herein disclosed may be resorted to by those skilled in the art, and that such modifications and variations are considered to be within the scope of this invention.

By “about” in relation to a given numerical value, such as for temperature and period of time, it is meant to include numerical values within 10% of the specified value.

The invention has been described broadly and generically herein. Each of the narrower species and sub-generic groupings falling within the generic disclosure also form part of the invention. This includes the generic description of the invention with a proviso or negative limitation removing any subject matter from the genus, regardless of whether or not the excised material is specifically recited herein.

Other embodiments are within the following claims and non-limiting examples. In addition, where features or aspects of the invention are described in terms of Markush groups, those skilled in the art will recognize that the invention is also thereby described in terms of any individual member or subgroup of members of the Markush group.

1. A catalyst comprising metal nanoparticles as active phase disposed on a solid support, and a porous layer comprising amorphous hafnium oxide disposed on the metal nanoparticles.

2. The catalyst according to claim 1, wherein the metal nanoparticles comprise a metal selected from the group consisting of platinum, palladium, cobalt, nickel, iron, iridium, aluminium, and alloys thereof.

3. The catalyst according to claim 1, wherein the metal nanoparticles have a size in the range from 0.1 nm to 5 nm.

4. (canceled)

5. The catalyst according to claim 1, wherein the metal nanoparticles have a surface density in the range from 80 ng cm⁻² to 900 ng cm⁻² on the solid support.

6. The catalyst according to claim 1, wherein the porous layer comprising amorphous hafnium oxide has a thickness in the range from 5 nm to 10 nm.

7. The catalyst according to claim 1, wherein the porous layer comprising amorphous hafnium oxide is nanoporous.

8. The catalyst according to claim 1, wherein the solid support is a carbon-based material.

9. (canceled)

10. The catalyst according to claim 1, wherein the catalyst is a catalyst for hydrogen generation.

11. A method of preparing a catalyst, the method comprising forming metal nanoparticles as active phase on a solid support, and disposing a porous layer comprising amorphous hafnium oxide on the metal nanoparticles.

12. The method according to claim 11, wherein forming the metal nanoparticles comprises using electron beam evaporation to deposit atoms, nanoclusters, or both atoms and nanoclusters of the metal on the solid support.

13. (canceled)

14. The method according to claim 12, wherein the electron beam evaporation is carried out at a pressure in the range from 1×10⁻⁹ torr to 1×10⁻⁸ torr.

15. (canceled)

16. The method according to claim 12, further comprising subjecting the solid support having the atoms, nanoclusters, or both atoms and nanoclusters of the metal disposed thereon to a temperature of 250° C. or less to allow the atoms, nanoclusters, or both atoms and nanoclusters of the metal to coalesce and form the metal nanoparticles on the solid support.

17. The method according to claim 11, wherein disposing the porous layer comprising amorphous hafnium oxide on the metal nanoparticles is carried out while the metal nanoparticles are being formed on the solid support.

18. The method according to claim 11, wherein disposing the porous layer comprising amorphous hafnium oxide on the metal nanoparticles comprises atomic layer deposition of a hafnium precursor and an oxygen precursor in alternating sequence at a temperature of 250° C. or less.

19. The method according to claim 18, wherein the hafnium precursor is [(CH₃)₂N]₄Hf.

20. The method according to claim 18, wherein the oxygen precursor is water.

21. The method according to claim 18, wherein the atomic layer deposition is carried out for a number of cycles in the range from 50 cycles to 100 cycles.

22. The method according to claim 18, wherein the atomic layer deposition is carried out with exposure time of the hafnium precursor and the oxygen precursor being independently selected from the range of 0.1 s to 0.5 s, respectively, and/or with waiting time for the reaction of the hafnium precursor and the oxygen precursor in the range of 3 s to 8 s.

23. (canceled)

24. The catalyst according to claim 1, wherein the metal nanoparticles are disposed directly on the solid support, and the porous layer is disposed on the metal nanoparticles and the solid support, wherein the porous layer anchors the metal nanoparticles on the solid support and defines channels for transfer of reactants and products to and from the metal nanoparticles.

25. The method according to claim 11, further comprising forming the metal nanoparticles directly on the solid support, wherein the disposing comprises disposing the porous layer on the metal nanoparticles and the solid support, and wherein the disposing comprises anchoring the metal nanoparticles on the solid support and defining channels for transfer of reactants and products to and from the metal nanoparticles.
